(19) United States
(12) Patent Application Publication
(10) Pub. No.: US 2011/0001805 A1
(43) Pub. Date: Jan. 6, 2011

(54) SYSTEM AND METHOD OF TRANSMITTING AND DECODING STEREOSCOPIC SEQUENCE INFORMATION

(75) Inventors: James Mentz, Gainesville, FL (US); Samuel Caldwell, Palm Harbor, FL (US)

Correspondence Address: AMPACC Law Group, PLLC, 6100 219th Street SW, Suite 580, Mountlake Terrace, WA, 98043, US

(73) Assignee: BIT CAULDRON CORPORATION, Gainesville, FL (US)

(21) Appl. No.: 12/819,158

(22) Filed: Jun. 18, 2010

Related U.S. Application Data
(63) Continuation-in-part of application No. 12/699,685, filed on Feb. 3, 2010.
(60) Provisional application No. 61/218,069, filed on Jun. 18, 2009.
(60) Provisional application No. 61/251,739, filed on Oct. 15, 2009.
(60) Provisional application No. 61/300,961, filed on Feb. 3, 2010.

(51) Int. Cl. H04N 13/04

(52) U.S. Cl. 348/55; 348/E13.036; 348/E13.059

(57) ABSTRACT

A method for driving a pair of three-dimensional glasses comprising receiving 3D video output signals from a source of 3D video signals, determining a plurality of synchronization signals in response to the 3D video output signals, and outputting radio frequency signals to the pair of three-dimensional glasses in response to the plurality of synchronization signals.

### CROSS-REFERENCES TO RELATED APPLICATIONS

The present patent application claims priority to application Nos. 61/218,069 filed Jun. 18, 2009, 61/251,739 filed Oct. 15, 2009, and 61/300,961 filed Feb. 3, 2010. The present patent application is also related to co-pending application Ser. Nos. 12/699,685 filed Feb. 3, 2010 and, 12/699,337 filed Feb. 3, 2010. The above disclosures are herein by incorporated by reference, for all purposes.

### BACKGROUND OF THE INVENTION

The present invention relates to stereoscopic 3D image viewing methods and apparatus. More particularly, the present invention relates to methods and devices that provide output to stereoscopic 3D image viewing devices.

When two-dimensional images that represent left and right points of view are sensed by respective left and right eyes of a user, the user typically experiences the perception of a 3D image from the two-dimensional images. The inventors are aware of several systems that allow users (e.g. individuals or groups) to perceive stereoscopic 3D depth in images, photos, pictures, moving pictures, videos, or the like, by the selective transmission of images to a users' eyes. Such systems include the use of display systems including light projection/reflection within a public or home theater or emissive or transmissive displays (e.g. LCD, plasma display, flat-panel display, or the like) to alternatively or simultaneously output right eye images and left eye images to a user. To view such 3D images, a variety of approaches have been provided to the user including prisms, static polarized glasses, LCD shutter glasses, or the like. The inventors of the present invention have recognized that existing approaches have many drawbacks, as will be discussed below.

One approach has been with the use of polarized glasses, where the left and right lenses have a fixed orthogonal polarization (e.g. clockwise-circular and counter-clockwise-circular polarization). The inventors of the present invention have determined that such systems have a number of drawbacks. One such drawback includes that such systems typically rely upon images provided by a light projector and thus such systems are limited for use in darkened environments. Another drawback includes that such systems typically reply upon expensive silver or metalized reflective screens, that maintain the appropriate polarization of light from the projector to the right and left eye images. Such screens are often too expensive for the average consumer. Additional drawbacks include that both left and right eye images are displayed to the user at the same time and polarizers are often imperfect, further, light can change polarization when it reflects off a screen, accordingly, despite the polarized glasses, right eye images are often visible to the left eye and left eye images are often visible to the right eye. This light pollution degrades the quality of the 3D images and can be termed as “ghosting” of 3D images.

The inventors are aware of a number of techniques that may be used to reduce this ghosting effect. Some techniques may include deliberate degradation of left eye images to account for right eye image ghosting and the deliberate degradation of right eye images to account for left eye image ghosting. The inventors believe that such techniques are disadvantageous as they tend to reduce the contrast of objects in an image, and they may result in a visible halo around objects in the image. As a result of using these circular or linear polarized glasses, the inventors have recognized that 3D versions of features often do not appear as aesthetically pleasing as 2D versions of such features.

Another approach to 3D visualization has included the use of stereoscopic shutter glasses that are based upon physical shutters, or more commonly liquid crystal display (LCD) technology. With such approaches, left and right images are alternatively displayed to the user, and the right and left LCD lenses alternate between a dark and transparent state. When the shutter glasses quickly alternate between transparency in the left then right eyes in synchronization with an image which presents alternating left and right points of view, the left and right eyes receive different 2D images and the observer experiences the perception of depth in a 3D image.

FIG. 1 illustrates a typical home user stereoscopic system. As illustrated, such systems typically include a computer 10 including a display interface, such as a VGA port, or the like. In such examples, two separate signals are transmitted from computer 10 downstream on a VGA port. Typically a graphics processing unit or graphics subsystem of computer 10 provides video signals via a VGA port, typically in the form of alternating left and right frames that make up alternating stereoscopic frame video signal. The data rate, e.g. pixel rate is relatively high. The video signals are transmitted through the lenses to the viewer as the visible light sensed by the viewer. The second signal sent from computer 10 is sequence information which provides information regarding when the transmission of a new frame is commencing and whether the new frame is a left frame or right frame. This data is typically transmitted along display port lines at a relatively low rate, e.g. 60 Hz. Accordingly, computer 10/GPU must specifically determine and output both signals along VGA port at different data rates.

As illustrated in FIG. 1, a dongle 30 is an adapter placed in-line with VGA port acts as a short VGA cable extender. As mentioned above, video and sequenced signals are determined by computer 10/graphics processing unit (GPU) and are multiplexed together by the graphics processing unit (GPU) or graphics subsystem. The signals are received at VGA port 20 by dongle 30 and are demultiplexed into separate video and sequence signals.

In the present example, the video signal is passively passed through dongle 20 on male VGA connector 40 and is allows to propagate on to the display 50. The right/left sequence information is extracted from the plug-and-play information present on the I2S bus (also known as the DDC2 bus) on the video cable. The sequence information is then made available to electrical connector 60 which can be directly cabled to shutter glasses 70 or to a connector 80 following the 1997 VESA Connector & Signal Standards for Stereoscopic Display Hardware standard. As illustrated, connector 80 may be coupled to an infra-red transmitter 90 which sends infra-red light to shutter glasses 95.

In response to the signals from connector 60, an IR transmitter outputs infrared data that indicate when the right eye image is being output and when the left eye image is being output. The inventors note that many different manufacturers currently have different IR data packet definitions and protocols. For example, one simple format for infrared data is a simple square wave with a high signal indicating left and a low signal indicating right; and another format includes a 8-bit word. Because of these different data formats, IR transmitters from one manufacturer often cannot be used with LCD glasses from another manufacturer.

In various systems, infrared data is received by LCD glasses 95, and in response, for example, the right LCD of the LCD glasses 95 becomes opaque and the left LCD becomes translucent (e.g. clear,), or the left LCD of the LCD glasses 95 becomes opaque and the right LCD becomes translucent. Ideally, at the same time the right LCD becomes translucent, display 50 is displaying a right eye image, and when the left LCD becomes translucent, display 50 is displaying a left eye image. A similar process is performed by shutter glasses 70.

In theory, systems illustrated in FIG. 1 are expected to provide a workable, robust system. However, in practice, then inventors have determined that there are many limitations that degrade the performance of such systems and that limit the applicability of such systems from being successfully and widely adopted. As merely an example, wired shutter glasses, such as shutter glasses 70 are almost never used now, as Consumers do not want tethered devices, e.g. remote controls, game controllers, shutter glasses.

One such limitation includes the difficulty in synchronizing the glasses to the images that are displayed. Synchronization data is typically based upon when the images are provided to the 3D display. Limitations to such approaches, determined by the inventors includes that both latency and timing jitter are introduced as it is processed and rendered by the 3D display device. In various embodiments, jitter as little as 50 microseconds or 10 microseconds can affect the performance of the glasses. As a result of such latency and jitter information, the LCD lenses or shutters are often opened and closed often at improper times, e.g. out of phase, with some of the image intended for the left eye being shown to the right eye and vice versa. This is perceivable by the user as light pollution or ghosting effects. Additionally, as the inventors have determined that the phase difference is not constant and is subject to jitter, the user may see the image brightness change or flicker undesirably.

One approach to reduce such latency or jitter effects has been to reduce the amount of time the left LCD shutter and the amount of time the right LCD shutter are translucent. In such approaches, instead of the left shutter being open for example 50% of the time, the left shutter may be open 35% of the time, or the like. This reduction in open time should reduce the amount of ghosting.

The inventors recognize drawbacks to such approach to image ghosting. One such drawback is the reduction in net amount of light transmitted to the user's eyes. In particular, as the exposure time for each eye is reduced, the user will perceive a darkening of the images for each eye. Accordingly, a 3D version of a feature will appear darker and duller compared to a 2D version of the feature when using shutter glasses.

Another limitation is the use of the IR communications channel itself The inventors of the present invention have determined that LCD glasses based upon IR receivers often lose synchronization with the display as a result of stray reflections. For example, it has been observed by the inventors that IR LCD glasses may become confused as a result of sunlight reflecting from household objects; heat sources such candles, open flames, heat lamps; IR remote controls (e.g. television remotes, game controllers); light sources (e.g. florescent lights); and the like. Additionally, it has been observed by the inventors that IR LCD Glasses may also lose synchronization as a result of clothing, hair, portions of other users bodies (e.g. head), or the like, that temporarily obscure an IR receiver of the LCD glasses. The loss of synchronization may lead the user to seeing a series of flickering or rolling images and/or the left eye seeing the right eye image. The inventors believe these types of anomalies are highly disturbing to most users and should be inhibited or minimized.

In some cases manufacturers of such devices specifically instruct users to use IR LCD glasses in highly controlled environments. For example, they suggest that the 3D displays and glasses be used only in darkened rooms. The inventors believe such a solution limits the applicability and attractiveness of such 3D display devices to typical consumers. This is believed to be because most consumers do not have the luxury of a dedicated, light-controlled room for a home theater, and that most consumer entertainment rooms are multipurpose family rooms.

An additional drawback to such devices, determined by the inventors, is that multiple 3D display systems cannot easily be operated in the vicinity of each other. As described above, each 3D display system includes its own IR transmitter and 2D field timing and phase data. Then, when two such systems are in close proximity, a user's IR LCD glasses may receive IR transmissions from either of the 3D display systems. Because of this, although a user is viewing a first 3D display, the user's 3D glasses may be synchronizing to a different 3D display, causing the user to undesirably view flickering and rolling images. The inventors of the present invention thus recognize that multiple 3D display systems cannot easily be used in applications such as for public gaming exhibitions, tournaments, or contests, trade shows, in stadiums, in restaurants or bars, or the like.

An additional drawback to current 3D systems includes that the 3D source, e.g. computer, DVD player, or the like, must specifically generate and provide switching signals for the 3D glasses. As illustrated in FIG. 1, computer 10/graphics processor specifically generates the switching signals and outputs these signals on VGA port 20. The inventors believe this is undesirable as it requires sources of 3D images, e.g. PS3, to be modified in firmware, or physically, to output such switching information.

Accordingly, what is desired are improved methods and apparatus for improved 3D image viewing without the drawbacks discussed above.

### BRIEF SUMMARY OF THE INVENTION

The present invention relates to stereoscopic 3D image viewing methods and apparatus. More particularly, the present invention relates to stereoscopic 3D image viewing devices incorporating robust synchronization capability.

In various embodiments of the present invention, a stereoscopic 3D image viewing device is based upon liquid crystal display (LCD) shutters that are synchronized to a source of 3D images. In various embodiments, the synchronization is based upon RF protocols such as Bluetooth, ZigBee radio (ZigBee Alliance), IEEE Standard 802.11, IEEE Standard 802.15.4, or any other type of RF communications protocol. In some embodiments of the present invention, the stereoscopic 3D image viewing device may transmit data back to the source of 3D images, via the RF communications mechanism or protocol, to increase the level of synchronization between the two devices.

In various embodiments, by using a multitude of communications protocols (e.g. RF) and adding feedback from 3D shutter glasses back to the 3D image source, a system, method, and apparatus of perceiving stereoscopic 3D can be generated which improves the level of synchronization between the alternating images and the alternating action of shutter glasses. A system, apparatus, method, and computer-readable media are provided to enable stereoscopic viewing. In particular, according to one method, the physical method of connecting the display system to stereoscopic glasses is the IEEE 802.11 wireless radio, IEEE 802.15.4 wireless radio, ZigBee radio or Bluetooth technology. This allows a user to move one's head into positions that would normally lose reception of wireless transmissions (e.g. IR) thus simplifying the user experience of wearing stereoscopic glasses. The wireless radio connection also has the advantage of replacing the infra-red light transmission method and its associated interference with remote controls and tendency to accept interference from natural and artificial light sources, thus enhancing the user experience.

In various embodiments, a shutter glasses control timer and multi-layer timer feedback loop are provided to 3D glasses for improved stereoscopic viewing. In particular, according to one embodiment, the control timer and multi-layer timer feedback loop operate the liquid crystal shutter action of the 3D glasses. Further, these components utilize the 3D source synchronization signal (e.g. system), in one example the VESA signal, along with RF-based communications mechanisms, as discussed herein, e.g. IEEE 802.15.4 wireless radio. The RF-based communications channel between the display system and the 3D stereoscopic glasses allows a user to move his head into positions and to locations that would normally cause loss of reception of 3D glasses based upon infrared transmissions. Further, the shutter control timer and multi-layer feedback loop improves the three dimensional perception by eliminating jitter and noise in the system (3D source) synchronization signal. In various embodiments, the shutter control timer and multi-layer feedback loop of the 3D glasses can quickly synchronize with the system synchronization signal and can maintain the synchronization of the display and shutter action of the glasses although actual synchronization may be temporarily lost. Such embodiments improve the user's 3D experience.

In various embodiments, such shutter control timer includes hardware based upon a microprocessor in the LC shutter glasses. In such embodiments, the microprocessor receives the timing information (e.g. system synchronization signals) received from the 3D system synchronization source via wireless signal and the feedback loop synchronizes the localized control timer within the 3D glasses with the system synchronization signal. Based upon the localized clock, in the short term absence of input synchronization information or in short periods of high signal jitter, the timer control system in the 3D glasses does not adjust the frequency of phase of the LCD switching, and relies upon its own internal clock. Accordingly, in such conditions, the synchronization between display and shutter action is maintained.

According to other aspects, a method is provided for synchronization between the video transmitter and the shutter glasses. Synchronization is provided via a protocol that provides timing information such as a beacon offset or any series of packets that is used as the energy to excite a clock. A precision timing protocol may be utilized to provide synchronization between the transmitter and the receiver.

The above-described subject matter may also be implemented as a computer-controlled apparatus, a computer process, a computing system, or as an article of manufacture such as a pair of electronic glasses, an earbud or headset, a computer program product or a computer-readable medium. These and various other features will be apparent from a reading of the following Detailed Description and a review of the associated drawings. In various embodiments, the shutter glasses and the transmission device may include executable computer programs resident in a memory that instructs a respective processor to perform specific functions or operations, such as to transmit data, to determine a latency, or the like.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect of the invention, a method for operating a pair of shutter glasses including a right LCD shutter and a left LCD shutter is disclosed. One process includes receiving synchronization data via radio frequency transmissions from a radio frequency transmitter, and determining shutter timings for the right LCD shutter and the left LCD shutter in response to the synchronization data. A technique may include applying the shutter timings to the right LCD shutter and the left LCD shutter to enable the viewer to view right-eye images via the right LCD shutter and left-eye images via the left LCD shutter.

According to another aspect of the invention, a method for transmitting stereoscopic display information includes: converting one or more video synchronization signals into wireless radio signals; and decoding the wireless radio signal in a pair of shutter glasses or other device; wherein the wireless radio is the IEEE Standard 802.11, WiFi, or components thereof.

According to another aspect of the invention, a method for transmitting stereoscopic display information includes: a pair of shutter glasses or other consumer electronics device which contains a localized clock such that the device remains synchronous to the video display system even when the connection to the source transmitting the synchronization information is interrupted or is not present. In some aspects, the synchronization information between the display system and the glasses or other device are determined by a precision timing protocol in which bidirectional communication of timing information occurs.

According to another aspect of the invention, a method for transmitting stereoscopic display information includes: a pair of shutter glasses or other consumer electronics device which receives synchronous information from the video display system, and a means and method of storing the delay and synchronization information in the transmitter or the video source generating computer, home theater system, or device. In some aspects, the delay and synchronization information are stored and then transmitted to multiple devices to allow multiple users to simultaneously use the same system.

According to another aspect of the invention, a method for transmitting stereoscopic display information includes: a pair of shutter glasses or other consumer electronics device which receives synchronous information from the video display system, and a means of determining the delay and synchronization information through information contained in the display and transmitter from the display via the video signal cable.

According to another aspect of the invention, a method for transmitting stereoscopic display information, the method including: a transmitter of synchronization information and a pair of shutter glasses or other consumer electronics device which is capable of receiving synchronization information from infrared, visible light and radio sources. In various aspects, the shutter glasses or other receiving device can incorporate a computer program which allows the device to automatically determine which source or sources of synchronization information are available and automatically use the best source or sources.

According to another aspect of the invention, shutter glasses includes various radio frequency receiving capability along with a feedback mechanism and a localized clock. The introduction of a synchronized timer in the shutter glasses improves the synchronization between the alternating source images and the alternating action of shutter glasses. It is with respect to these considerations that a LC shutter control timer and multi-layer timer feedback loop are provided for improved perception of stereoscopic 3D viewing.

According to another aspect of the invention, a method of combining stereoscopic glasses with a wireless headset, Bluetooth headset, or stereo Bluetooth headset is disclosed.

According to another aspect of the invention, a method of combining ordinary or automatically darkening sunglasses with a wireless headset, Bluetooth headset, or stereo Bluetooth headset is disclosed.

According to another aspect of the invention, a three-dimensional viewing device for providing images to a user is disclosed. One apparatus includes a receiver configured to receive source 3D synchronization signals from a transmitting device, wherein the source 3D synchronization signals comprise a source frequency and a source phase. A device may include a plurality of LCD shutters including a right LCD shutter and a left LCD shutter, wherein the right LCD shutter and the left LCD shutter are configured to alternatively enter a translucent state in response to local 3D synchronization signals. A system may include a localized timing source coupled to the receiver and to the plurality of LCD shutters, wherein the localized timing source is configured to generate the local 3D synchronization signals in response to the source 3D synchronization signals, and an adjustment portion coupled to the localized timing source and to the receiver, wherein the adjustment circuit is configured to adjust parameters of the local 3D synchronization signals in response to parameters of the source 3D synchronization signals.

According to yet another embodiment, a method for operating a three-dimensional viewing device including a right LCD shutter and a left LCD shutter is disclosed. One method includes receiving source 3D synchronization signals from a transmitting device, wherein the source 3D synchronization signals comprise a source frequency and a source phase, and generating a local 3D synchronization signals in response to the source 3D synchronization signals. A process may include adjusting parameters of the local 3D synchronization signals in response to parameters of the source 3D synchronization signals, and driving the right LCD shutter and the left LCD shutter with the local 3D synchronization signals, wherein the right LCD shutter and the left LCD shutter are configured to alternatively enter a translucent state in response to local 3D synchronization signals.

According to one aspect of the invention, a device for driving a pair of three-dimensional glasses is disclosed. One apparatus includes an interface portion configured to receive 3D video output signals from a source of 3D video signals, and a decoding portion configured to determine a plurality of synchronization signals in response to the 3D video output signals. A system may also include a radio frequency transmitter configured to output radio frequency signals to the pair of three-dimensional glasses in response to the plurality of synchronization signals.

According to another aspect of the invention, a method for driving a pair of three-dimensional glasses is disclosed. One technique includes receiving 3D video output signals from a source of 3D video signals, and determining a plurality of synchronization signals in response to the 3D video output signals. A process may include outputting radio frequency signals to the pair of three-dimensional glasses in response to the plurality of synchronization signals.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1is a block diagrams illustrating aspects of the prior art;

FIGS. 2A-D include block diagrams of various embodiments of the present invention illustrating the process of elements of a system in which stereoscopic glasses are synchronized with the display device by incorporation of a wireless radio into the system;

FIG. 3 illustrates a block diagram of a process according to various embodiments of the present invention;

FIG. 4 is a timing diagram of various embodiments of the present invention illustrating a method of sending image information to a display in which the frames which compose the image are sent sequentially;

FIG. 5 illustrates various embodiments incorporated into a mobile phone's hardware, firmware, and software and into a pair of stereoscopic shutter glasses;

FIG. 6 illustrates various embodiments incorporated into a mobile phone, some of the methods are incorporated into a pair of stereoscopic shutter glasses, and other methods are incorporated into a cradle or other device that attaches to the mobile phone;

FIG. 7 illustrates various embodiments incorporated into a pair of stereoscopic shutter glasses combined with a mobile phone headset;

FIGS. 8A-C illustrate various embodiments of the present invention; and

FIG. 9 illustrates various embodiments of the present invention.

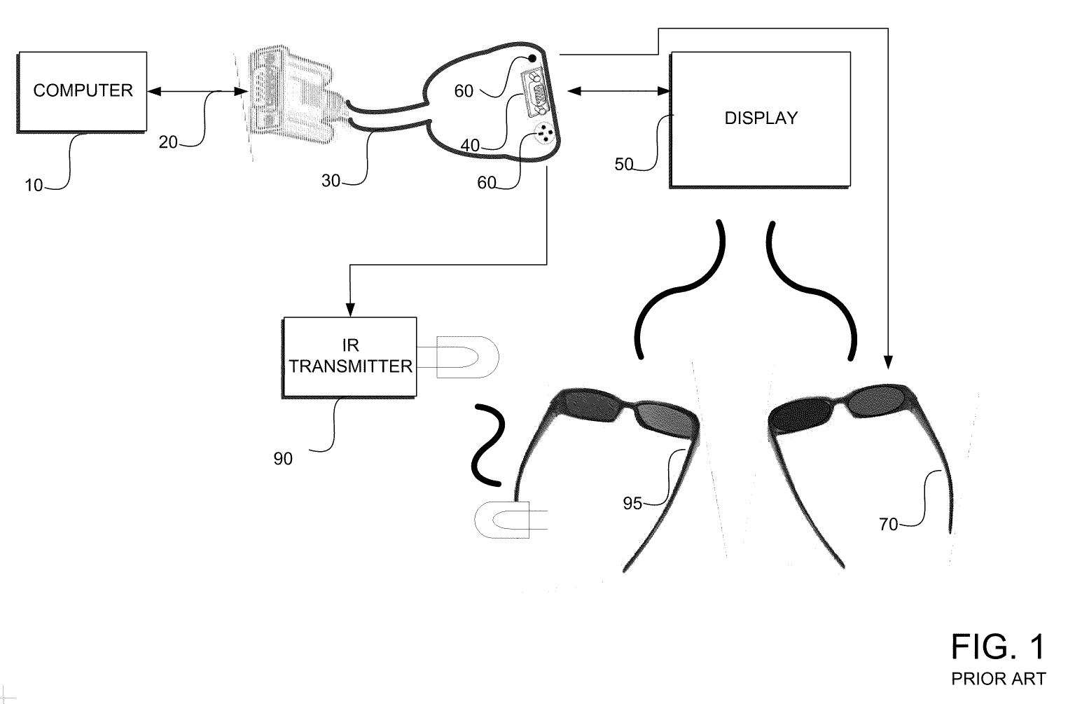

### DETAILED DESCRIPTION OF THE INVENTION

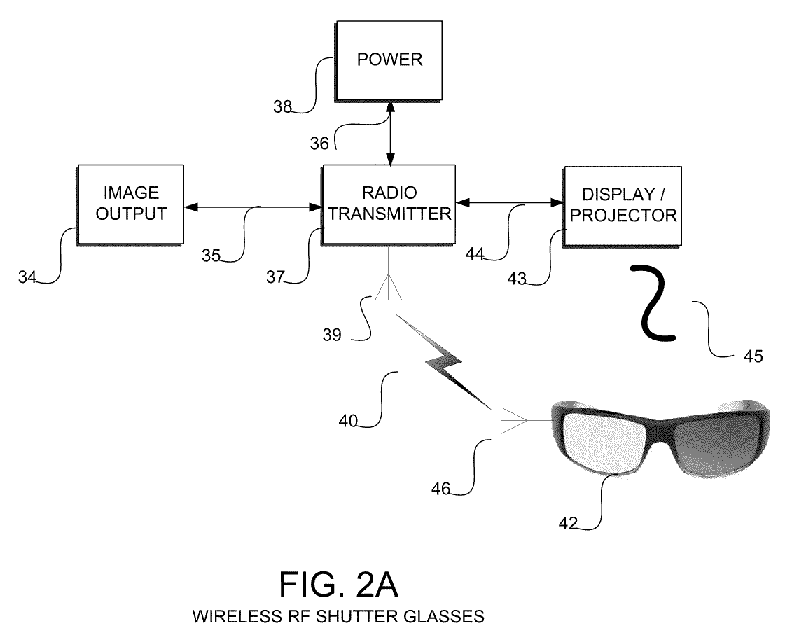

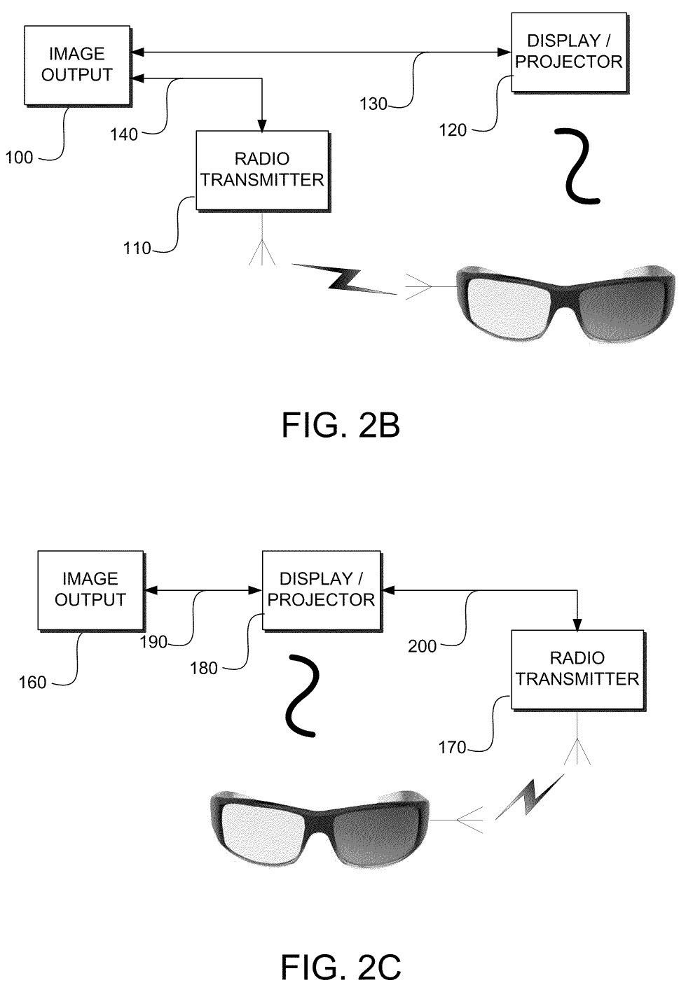

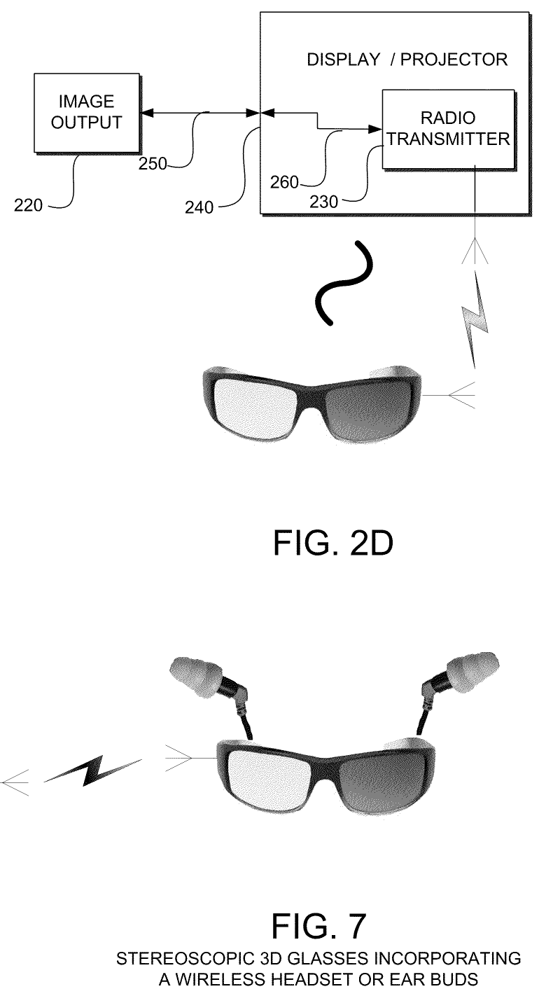

FIGS. 2A-D illustrate various embodiments of the present invention. In particular, FIGS. 2A-D illustrate various arrangements of embodiments of the present invention.

FIG. 2A includes a 3D source 34 of image data, a transmission device 37, a display 43, and shutter glasses 42. In various embodiments, 3D source 34 may be a computer, a Blu-ray or DVD player, a gaming console, a portable media player, set-top-box, home theater system, preamplifier, a graphics card of a computer, a cable box, or the like, and 3D display 43 may be any 3D display device such as an LCD/Plasma/OLED display, a DLP display, a projection display, or the like. In various embodiments, transmission device 37 and shutter glasses 42 may be embodied by a product developed by the assignee of the current patent application, Bit Cauldron Corporation of Gainesville, Fla. In some embodiments, shutter glasses 42 may be implemented with mechanical shutters or LCD shutters. For example, LCD shutters based upon twisted nemic, super-twisted nemic, or pi-cell technology, may be used.

In operation, 3D source 34 sends 3D display signals to display 43 through a video cable 35, typically through a standards-based interface such as VGA, DVI, HDMI, Display Port (DP), or the like. Such 3D display signals are often configured as one or more interleaved full right-eye images then full left-eye images (e.g. field sequential); double wide (e.g. side by side) or double height (e.g. stacked) images including both left and right images; images interleaved with right-eye images and left-eye images on a pixel by pixel basis; or the like. As shown in FIG. 2A, a transmission device 37, e.g. a radio transmitter may be inserted between the 3D source 34 or other video source and 3D display 43.

In various embodiments, in transmission device 37 determines 3D timing information by decoding the 3D display signals as they pass through to display 43 on signal line or cable 44. In FIG. 2A, transmission device 37 includes a transmitter based upon radio frequency (RF) signals. The RF signals may use or may be combined with any conventional transmission protocol such as IEEE Standard 802.15.1 (e.g. Bluetooth), IEEE 802.11 (e.g. Wi-Fi), IEEE Standard 802.15.4 (e.g. ZigBee Alliance radio), or the like. In various embodiments, synchronization signals 46 are then transmitted via antenna 39.

In various embodiments, transmission device 37 may be a stand-alone device, e.g. a dongle, a USB “key,” or the like and transmission device 37 may be powered by power source 36 and 38, self-powered, powered from 3D data source, USB powered, or the like. In other embodiments, transmission device 37 may incorporated into another device, such as 3D source 34, 3D display 43, a pre-amplifier, or the like.

FIG. 2B illustrates additional embodiments of the present invention. In particular, FIG. 2B includes a source of 3D images 100, a transmission device 110, and a 3D display 120. As illustrated, 3D image source 100 provides 3D images (e.g. double-wide or double-height images including both right and left images) to 3D display 120 via a signal line 130 such as a VGA, DVI, Display Port (DP), cable, or the like. Additionally 3D image source 100 provides a synchronization signal along signal line 140 to transmission device 110. In various embodiments, 3D image source 100 includes an industry standard interface such as a VESA miniDIN-3 connector, VESA 1997.11, USB connector, or the like, to which transmission device 110 may be coupled.

FIG. 2C illustrates additional embodiments of the present invention. In particular, FIG. 2C includes a source of 3D images 160, a transmission device 170, and a 3D display 180. As illustrated, 3D image source 160 provides 3D images (e.g. double-wide or double-height images including both right and left images) to 3D display 180 via a signal line 190 such as a VGA, DVI, HDMI cable, Display Port (DP), or the like. In turn, 3D display 180 provides a synchronization signal along signal line 200 to transmission device 170. In various embodiments, 3D display 180 includes an industry standard interface such as a VESA miniDIN-3 connector, USB connector, or the like, to which transmission device 170 may be coupled.

FIG. 2D illustrates other additional embodiments of the present invention. In particular, FIG. 2D includes a source of 3D images 220, a transmission device 230, and a 3D display 240. As illustrated, 3D image source 220 provides 3D images (e.g. double-wide or double-height images including both right and left images) to 3D display 240 via a signal line 250 such as a VGA, DVI, HDMI cable, Display Port (DP), or the like. In these embodiments, transmission device 230 may be disposed within 3D display 240. For example, transmission device 230 may be installed within the manufacturing facility of 3D display 240, or the like. In such embodiments, 2D display 240 may also power transmission device 230. Similar to the embodiments described above, 3D display 240 provides a (derived) synchronization signal along signal line 260 to transmission device 230.

In various embodiments described herein, shutter glasses 42 include a radio receiver 41 that receives the synchronization signals 40. In response to synchronization signals 40, shutter glasses 42 alternatively changes the properties of one lens from translucent to opaque (e.g. dark) to translucent and of the other lens from opaque to translucent (e.g. clear) to opaque. Because the shutters of shutter glasses 42 operate under the direction of synchronization signals 40, a user/viewer, views 3D display images 45 from display 43 at the proper timing. More particularly, the user's right eye is then exposed to a right-eye image from 3D display images 45, and then the user's left eye is then exposed to a left-eye image from 3D display images 45, etc.

The inventors of the present invention recognize that transmission device 37 based upon a radio frequency transmitter has several advantages over an infrared transmitter. One advantage recognized is that radio signals can be received in many situations where an infrared signal would be blocked. For example this allows the user of a pair of 3D shutter glasses or the like, to move their head much farther away from the 3D display or transmission device than if IR were used, and allows the user to move throughout a room with a larger range of motion while maintaining synchronization with the 3D display. As another example, RF transmitters allow other people or objects to pass in front the user/viewer without interrupting the signal.

Another advantage goes beyond the improved range and reliability of radio technology for synchronization purposes. For the example, the inventors believe that the avoidance of infrared is itself a benefit, as infrared signals can interfere with remote controls, such as those popular in households and home theater systems. Additionally, another benefit includes that IR receivers are often interfered with and are confused by IR remote controls, natural and artificial light sources, and video displays themselves

In various embodiments of the present invention, shutter glasses 42 may include its own localized clock. Benefits to such a configuration include that it allows shutter glasses 42 to remain approximately synchronized to display 43 even though the connection to transmission device 37 is interrupted and/or synchronization signals 40 are not received.

In various embodiments, a precision timing protocol can be used so that the clock that is local to shutter glasses 42 is synchronized with a clock within transmission device 37 and/or the 3D display signals. A precision timing protocol may include the transmission of data packets with a time stamp time associated with the 3D display signals to shutter glasses 42. In other embodiments, the protocol may include transmission of a data packet with a time stamp associated with shutter glasses 42 to transmission device 37. In operation, shutter glasses 42 receive the time stamp from the 3D data source, compares the received time stamp to its local clock and returns a data packet with its local time stamp. Using this information, transmission device 37 can determine a round-trip time for data between transmission device 37 and shutter glasses 42. In some embodiments of the present invention, the round-trip time offset is evenly divided between transmission device 37 and shutter glasses 42. In other embodiments, if one or both devices are capable of determining a difference in speed or lag between the two transmissions, then a more precise determination of the relative values of both clocks (offsets) can be determined. As a result, in various embodiments, more precise synchronization between the two clocks can be established.

In various embodiments of the present invention, by repeating this process periodically, the difference in rate (e.g. frequency) between the two clocks (transmission device 37 or 3D source 34 and shutter glasses 42) can be more precisely determined In some embodiments if there is a low degree of consistency in the latencies, the period of time between the determination of a latency process may be made small, e.g. once a minute; and if there is a higher degree of consistency in the latencies, the period of time between the determination of a latency process may be increased, e.g. once every ten minutes.

Embodiments of the present invention enable the use of multiple pairs of shutter glasses 42. In such embodiments, a single pair of shutter glasses 42 may be used to determine delay and jitter as discussed was discussed above. Next, a simpler protocol, such as a unidirectional or broadcast protocol, may be used by transmission device 37 to communicate this synchronization information to the remaining pairs of shutter glasses. In various embodiments, the delay and jitter information can be stored in transmission device 37, in 3D source 34, or other consumer electronics device generating the 3D data, either in a volatile or non-volatile manner.

In other embodiments of the present invention other methods can be used to determine the synchronization and delay information. In various examples, this data may be determined using bidirectional communications on cable 44, such as the DisplayPort protocol, or the like, as illustrated in FIG. 2C. Communications protocols such as display data channel (DDC and DDC2) protocols, PanelLink serial protocol or a similar protocols allows the display to communicate information back to the computer, home theater system, video source, or the like. In various embodiments, this serial protocol can be enhanced to provide the appropriate latency and synchronization characteristics of 3D display 43 back to 3D source 34 and/or transmission device 37. In other embodiments, these protocols can be used to determine the manufacturer, vendor, or other identifying information for 3D display 34, and a table of pre-determined synchronization information can be retrieved, either locally, across a local area network, across a network, or the like This information may include an appropriate delay and synchronization information for respective 3D displays.

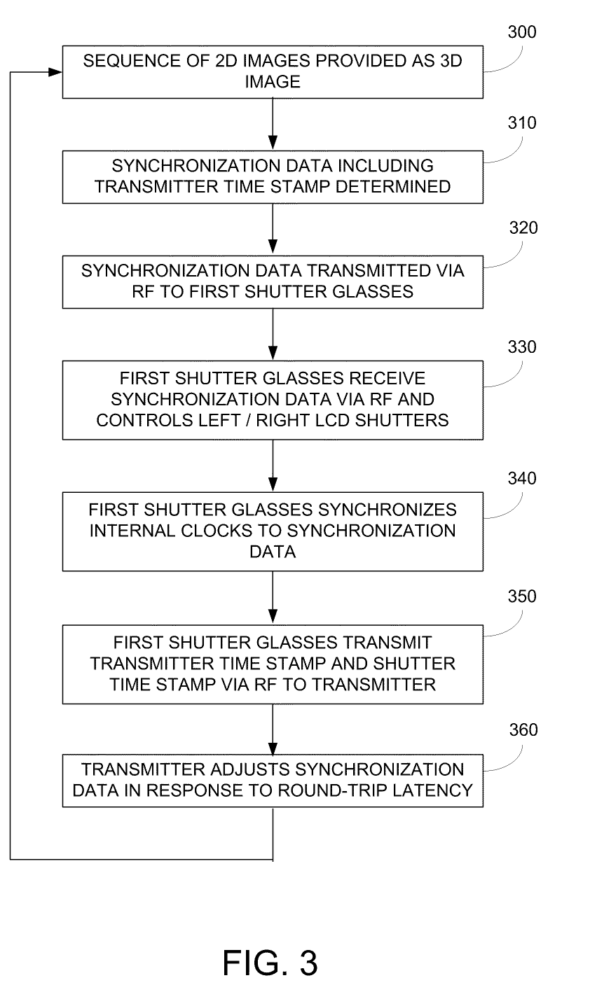

FIG. 3 illustrates a block diagram of a process according to various embodiments of the present invention. More specifically, FIG. 3 illustrates a process for synchronizing shutter glasses to a source of 3D images.

Initially, a 3D data source provides 3D images, step L. In various embodiments, the 3D images may be provided in any number of specific formats, such as right and left images: sequentially transmitted, packed vertically or horizontally into a single image and transmitted, combined on a pixel by pixel basis into a single image and transmitted, or the like. In other embodiments, as illustrated in FIG. 2B, 3D data source may provide specific timing data.

Next, in response to the data from 3D data source, synchronization data, such as an identifier of a timing clock resident on 3D data source is determined, step 310. In various embodiments, this may include a packet of data including a source time stamp, or the like. The synchronization data may then be transmitted through radio frequency transmissions to a first pair of shutter glasses, step 320.

In various embodiments, the shutter glasses receive the source time stamp and synchronizes the operation of the right/left shutters to the synchronization data, step 330. The synchronization data can then be maintained within the shutter glasses by an internal clock within such glasses, step 340. As synchronization data is received, the internal clock can be resynchronized. Such embodiments are believed to be advantageous as the glasses need not wait for synchronization data from the 3D data source to be able to switch. Accordingly, synchronization data from the transmission device may be dropped or lost while the shutter glasses continue to operate properly. When synchronization data is reestablished, the synchronization described above may be performed.

In various embodiments of the present invention, RF communications using the ZigBee radio (IEEE 802.15.4 standard) occur at 2.4 GHz, the same band as most Wi-Fi transmissions. In the case of interference with Wi-Fi transmissions, embodiments of the present shutter glasses are designed to inhibit communications, and defer to such Wi-Fi signals. As discussed above, in some embodiment, the shutter glasses will continue to operate autonomously, until the interference stops and new synchronization data is received from the transmission server.

In some embodiments of the present invention, the shutter glasses may transmit data back to the RF transmission device. More specifically, the shutter glasses may transmit the received source time stamp and/or the glasses time stamp back to the transmission device via the same RF communications channel, or the like, step 350.

In FIG. 3, in response to the received source time stamp and/or the glasses time stamp, and the source time stamp when these data are received, the transmission device may determine adjustments to subsequent synchronization data that will be sent to the shutter glasses, step 360. As an example, the transmission device may determine that it should output synchronization data to the shutter glasses, even before the synchronization data is determined or received from the 3D data source. As a numeric example, if it is determined that the shutter glasses lag the 3D data source by 100 microseconds, the shutter glasses may trigger its shutters 100 microseconds before the expected arrival of a synchronization pulse.

In various embodiments of the present invention, this adjustment to synchronization data may be used to drive 3D glasses of other viewers of the 3D image. In other embodiments of the present invention, 3D glasses of other viewers in the room may also have synchronization data adjusted using the process described above. In such embodiments, the transmission device may output the synchronization data at different times for different 3D glasses.

In other embodiments, other adjustments may be performed by the shutter glasses. For example, based upon received time stamps and the shutter glasses own internal clocks, the shutter glasses may verify that they are in sync. If not, the shutter glasses may adjust the frequency of its own internal clocks until they are kept in a higher amount of synchronization.

As seen in FIG. 3, the process may be repeated. In various embodiments, the synchronization process may be performed periodically, with the period dependent upon how well the 3D data source and the shutter clock stays remain in synchronization—if highly synchronized, the synchronization process may be performed at longer time periods apart (e.g. 2 minutes) than if these devices continually have synchronization problems (e.g. every 10 seconds). Further detail regarding the above synchronization process may be found in the provisional application referenced above.

Various embodiments of the present invention may include shutter glasses or other devices that includes multiple physical methods for receiving synchronization information. For example, some embodiments may contain both an infrared and radio receiver; an infrared and visible light receiver; a radio or visible light receiver; a combination of infrared, visible light and radio receivers; or the like. In such embodiments, the shutter glasses or other receiving device may include executable computer program that instructs a processor to automatically determine which communications channel or channels are available, and automatically use the communications channel having the strongest signal, lowest number of dropped data packets, or the like.

In various embodiments, the combination of a visible light receiver (e.g. IR) with another synchronization transmission technology (e.g. RF) may be advantageous. More specifically, the information transmitted via visible light and the synchronization information transmitted via another transmission technology may be combined within shutter glasses 42 to deduce unknown elements of the delay in 3D display 43 and other synchronization information. In various embodiments, the data from the different communication channels are compared to more precisely synchronize 3D display 43 and shutter glasses 42. As merely an example, the two communications channels can be used to verify that a left image displayed on 3D display 43 is going to the left eye and the right image displayed on 3D display 43 is going to the right eye. In such an example, this would preventing the error of a reversal of synchronization information somewhere in the system that results in the sending the left image to the right eye and vice versa.

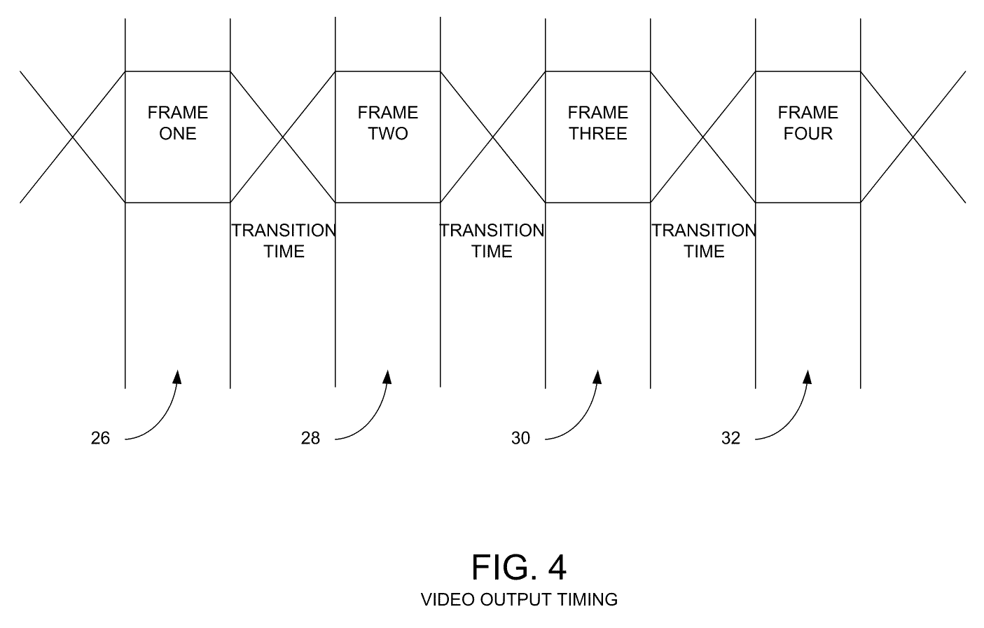

In various embodiments of the present invention, shutter glasses 42 may used to provide a variety of new functions. FIG. 4 illustrates typical video output timing where frame one 26, frame two 28, frame three 30 and frame four 32 are output sequentially. In some embodiments, left images (frames) and right images (frames) are alternatively output. For example, frame one 26 is left, frame two 28 is right, frame three 30 is left and frame four 32 is right, creating the sequence L, R, L, R images to the user.

Various embodiments of the present invention may be applied to 3D displays having display rates on the order of 120 Hz and higher. In embodiments where the refresh rate is 120 Hz, right and left images will be displayed and refreshed at 60 Hz. Accordingly, the viewer should not be able to detect significant flickering, however, the viewer may detect a darkening of the images. As refresh rates for future televisions, projectors or the like, are increasing, the inventors have determined that the higher refresh rate may enable new features, as described below.

In various embodiments, depending upon the output frame rate of the 3D display, more than one left image and right image may be output. For example, in various embodiments, multiple viewers may view a 3D display, and different viewers may see different 3D images. For example, a two viewer sequence of output images may be user 1 left, user 1 right, user 2 left, user 2 right, etc. This could be represented as: L1, R1, L2, R2. In such examples, shutter glasses of a first viewer will allow the first viewer will see images L1 and R1 and a shutter glasses of a second viewer will allow the second viewer will see images L2 and R2. In other examples, other sequences are contemplated, such as L1, L2, R1, R2, and the like. With respect to refresh rate, for a 3D display having a 240 Hz refresh rate, a viewer will see the respective right and left images at a refresh rate of 60 Hz. As noted above, this frequency should be above the typical sensitivity of the eye, however, viewers may detect a darker image. Such artifacts may be mitigated by increasing the brightness of the images, or the like.

Other embodiments may be extended to additional (e.g. three or more viewers). Applications of such embodiments may include for computer or console gaming, or the like. As an example, two or more viewers may initially see the same 3D image, and subsequently one or more viewers “break off” to view a different 3D image. For example, three people could be playing a multiplayer game in which all three are traveling together and see the same 3D images. Next, one player then breaks away from the other players. Using the additional communications protocols disclosed in various embodiments of the present invention, the player's glasses can be reprogrammed to allow the third person to see a different 3D image. Subsequently, the third person may return to the group, and then see the same 3D image. In such an example, a sequence of images output by the 3D display could begin with L0-R0-L0-R0, where 0 indicates everyone in the party. Next, when the third person leaves the party, the 3D display could switch and output images in a sequence such as L1&2, R1&2, L3, R3; L1&2, L3, R1&2, R3; or the like. When the third person returns to the party, the sequence may revert to L0, R0, L0, R0. In various embodiments, switching back and forth may occur with little, if any, visible interruption in the 3D images viewed by the viewer. In various embodiments, the inventors recognize that the brightness of each frame may have to be adjusted to correct for the changes in overall viewing time.

In other embodiments, other sequences of images enable still other types functionality. For example, one sequence of frames can be sent such that viewers wearing 3D glasses see a stereo display and viewers without glasses see only one side of the image (e.g. left or right). In such an example, a three frame sequence may include: Left, Right, Left-minus-Right. In response, a user using embodiments of the present invention may see a stereoscopic image by viewing the left image in their left eye and the right image in their right eye. That user would be prevented from viewing the Left minus Right image. To a viewer without the glasses, they would see in succession: L, R, (L−R)=2L, or only the left image with both eyes. In other embodiments, separate anti-left, anti-right images or both may also be sent. With such embodiments, theater-goers can decide whether they care to watch the same movie or feature with or without 3D glasses; game players can play in 3D while viewers watch the same display in 2D.

In still other embodiments, users not utilizing embodiments of the 3D glasses may view other arbitrary images. As an example, a sequence may be: Left, Right, and Arbitrary-minus-Left-minus-Right=Arbitrary image. In operation, the viewer with 3D glasses may see the left image in the left eye and the right image in the right eye, and may not see the Arbitrary image. Further, the viewer without 3D glasses would see the arbitrary image, in succession: L, R, (A−L−R)=A, that may be a non-stereo version of the same program, a blank or solid color screen, or a completely different piece of content such as an advertisement, a copyright warning, or the like.

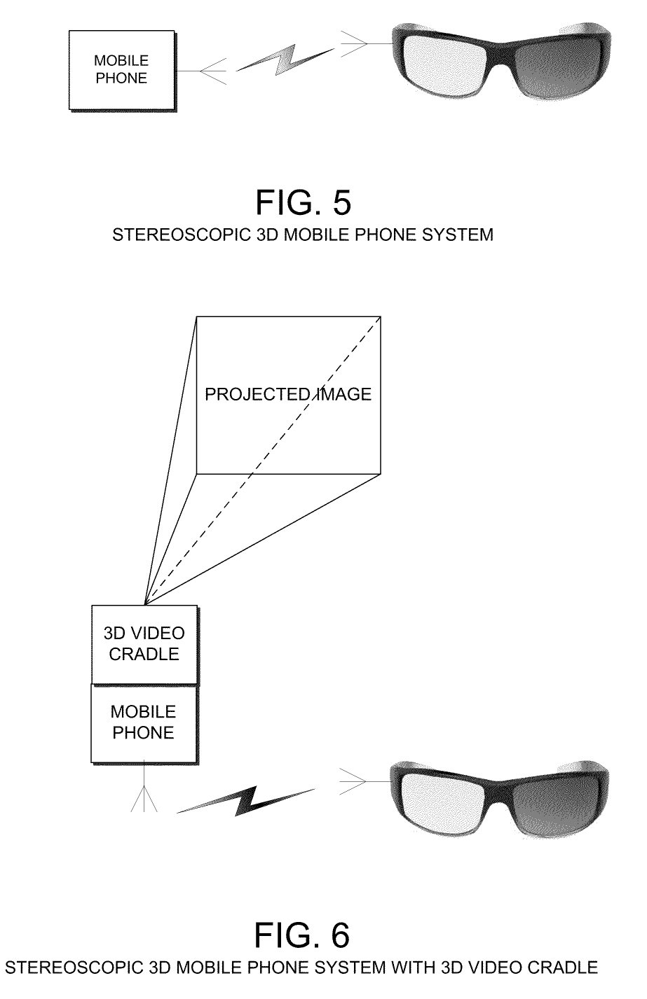

FIG. 5 illustrates additional embodiments of the present invention. More specifically, FIG. 5 illustrates a general purpose consumer device (e.g. mobile phone, personal media player, laptop, or the like) capable of 3D image output. In such embodiments, the synchronization information to the shutter glasses may be provided by with the consumer device including embodiments of the RF transmitter described above, or unused or available transmitters available in the consumer device. Various examples may use infrared, WiFi, Bluetooth, or the like, to provide synchronization signals to shutter glasses according to embodiments of the present invention.

FIG. 6 illustrates additional embodiments of the present invention wherein existing consumer devices (e.g. mobile phone) may be augmented to better support stereoscopic 3D viewing. In various embodiments, a cradle or dongle which attaches to the mobile device or holds the mobile device may be used. In such examples, the cradle or dongle may incorporate a projection system such that the image may be projected at a larger size than the screen on the mobile device. The cradle or dongle or consumer device may also provide the synchronization signals to the shutter glasses. For example, the cradle or dongle may include a ZigBee radio-type transmitter (IEEE 802.15.4) that transmits the synchronization data to the shutter glasses, or the like.

In other embodiments of the present invention, stereoscopic shutter glasses that are to be used with the consumer device described above, can be used for other purposes. For example, if such glasses incorporate a visible light sensor, they can be worn as ordinary sunglasses but make improved automatic decisions about the appropriate level of perceived darkening. This information can be based on computer algorithms, information about the user and the environment that is stored on a mobile device; information retrieved from a computer network via the mobile device, and the like.

FIG. 7 illustrates yet another embodiment of the present invention. In such embodiments, a user of the consumer device may desire to perform multiple functions at the same time, such as: talk on a Bluetooth headset, view stereoscopic 3D content, and wear sunglasses. Embodiments illustrated in FIG. 7 may include a pair of shutter glasses 57 combined with a pair of sunglasses and a Bluetooth or stereo mobile Bluetooth headset with a left earpiece 58 and a right earpiece 55, or the like.

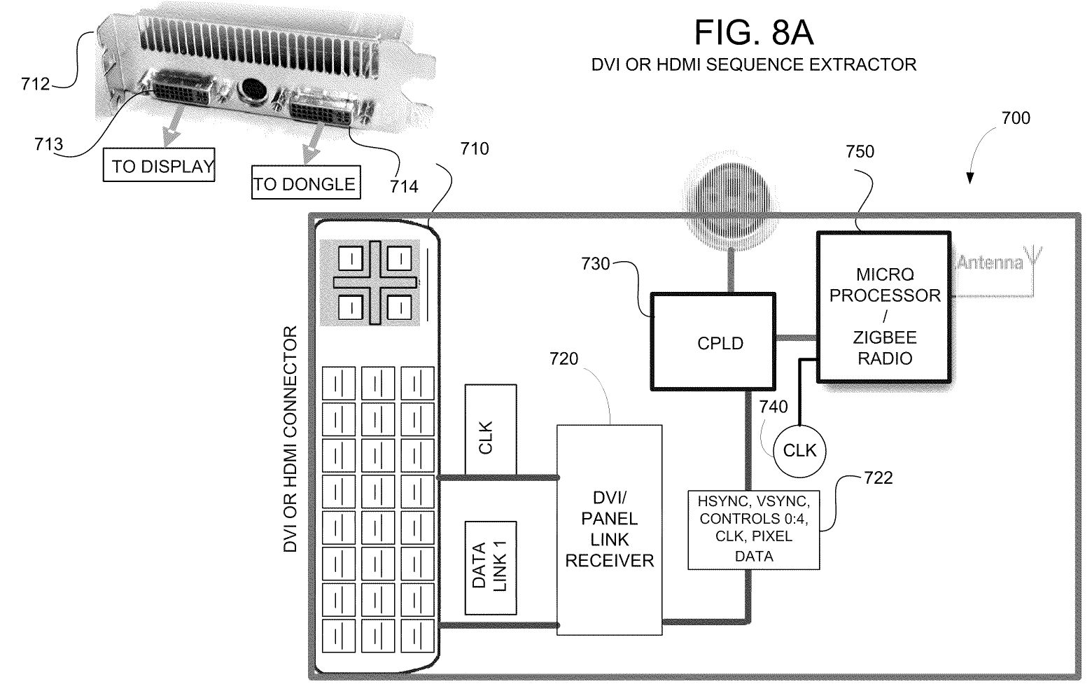

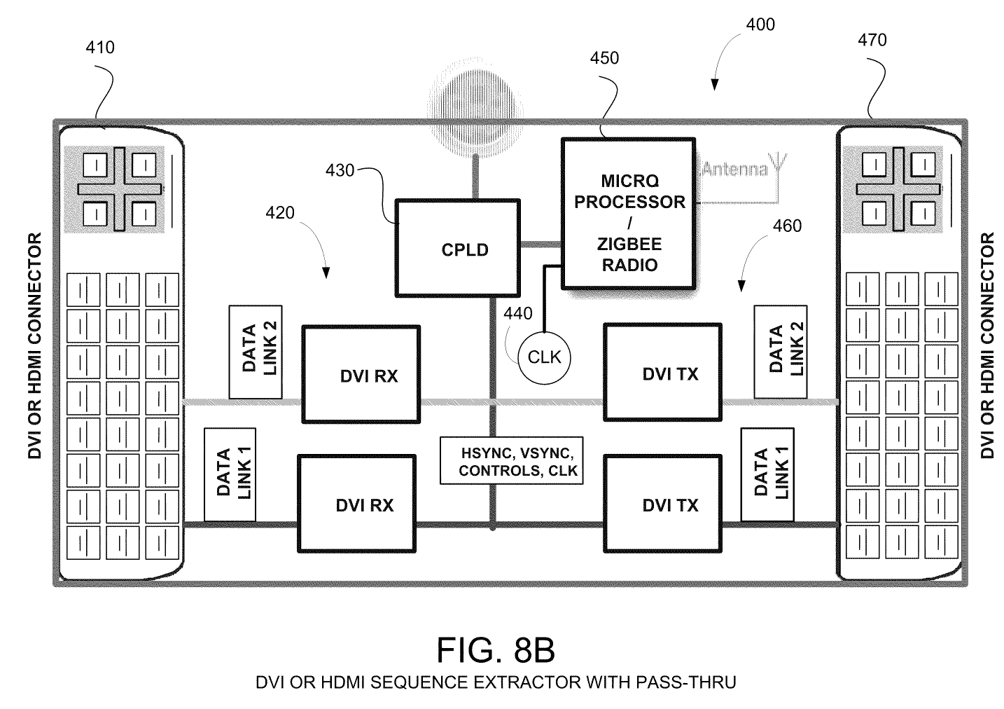

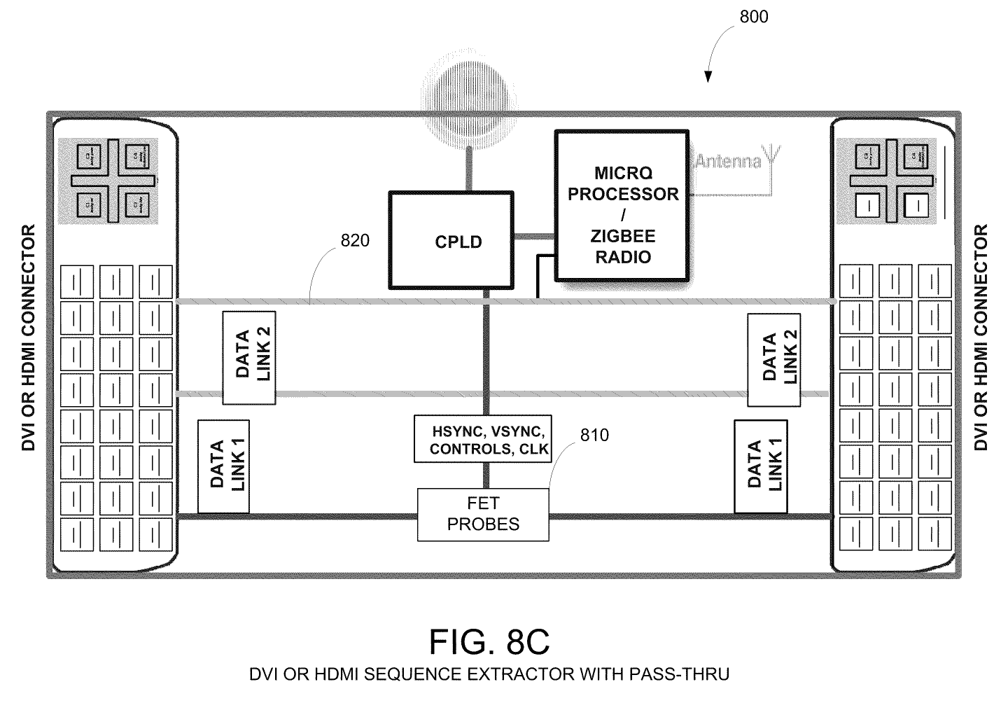

FIGS. 8A-C illustrate various embodiments of the present invention. In particular, FIGS. 8A-C illustrate block diagrams of various embodiments of a dongle providing RF transmissions, for example, as described above.

In FIG. 8A, a physical interface 710 is illustrated. In various embodiments, physical interface 710 may be a DVI port, HDMI port, Display Port (DP), USB, VESA 1997.11, or the like, for coupling to a source of 3D data 712 (e.g. computer, DVD/BluRay player, HD display, monitor, etc.). In embodiments illustrated in FIG. 2B, a port 712 may drive a display, and a port 714 may drive a dongle 700.

In various embodiments of the present invention, an interface chip or block 720 may provide the electronic interface to physical interface 710. As illustrated, signals including horizontal synchronization signals (HSYNC), vertical synchronization signals (VSYNC), control signals, and a clock may be derived from the video data. Next, a processing device such as a CPLD (complex programmable logic device) 730 may be used to decode 3D synchronization data from 3D image data or 3D timing data. More specifically in various embodiments, sequence information is multiplexed directly into the video picture data from the source of 3D data 712. The digital picture data is demultiplexed with receiver 720 into its component video and control data streams 722, described above, such that each stream can be examined, or the streams can be examined relative to each other. In other embodiments, the sequence information can be further demultiplexed from the digital video information.

As mentioned above, Complex Programmable Logic Device (CPLD) 730 further decodes the sequence data. CPLD 24 is useful in various embodiments as the 3D sequence data that is encoded into a digital signal is very fast, typically as fast as 165 MHz. This is much faster compared to the typical 8-32 MHz speed of microprocessor 750, accordingly, microprocessor 750 typically cannot decode this stream of data. As the Control, VSYNC and HSYNC information, or the like 722 is not transmitted at every moment in time, CPLD 730 and microprocessor 750 further decode the sequence information into continuous information. In other words, the Control data, VSYNC and HSYNC information (sequence information) are provided at the frequency of the video data (e.g. HDMI, DVI) (e.g. within the range of 32 MHz to 165 MHz to 340 MHz, although in the future, the pixel video data frequency may be even larger. However the sequence information must be converted to the appropriate left/right frame rate (e.g. 60 Hz, 120 Hz, 240 Hz, 480 Hz, or the like.)

In various embodiments of the present invention, microprocessor 750 includes an RF interface that references a clock 740. In some embodiments, microprocessor 450 is a TI CC2530 System on a Chip, that includes a 8051 MCU (processor), RAM, Flash memory, and a IEEE 802.14.4 ZigBee RF transceiver. The flash memory is configured to store executable computer code or instructions that directs the processor to perform various functions, as described herein. In various examples, the flash memory includes computer code that directs the processor to transmit the 3D synchronization data to the 3D glasses, to receive timing data back from the 3D glasses, to determine a round-trip communication latency, to adjust 3D synchronization data in response to the round-trip communication latency, and the like, as described above.

In various embodiments, using the IEEE 802.14.4 ZigBee RF transceiver of the like, 3D synchronization data can be sent to the wireless glasses. In other embodiments, an additional VESA 1997.11 port may also be provided for wired-glasses, as shown.

FIG. 8B, a physical interface 410 is illustrated. In various embodiments, physical interface 410 may be a DVI port, HDMI port, Display Port (DP), USB, VESA 1997.11, or the like, for coupling to a source of 3D data (e.g. computer, DVD/BluRay player, HD display, monitor, etc.). In embodiments illustrated in FIG. 2A or 2C for example, the 3D data may include 3D image data. Embodiments illustrated in FIG. 8B contemplate a pass-through type dongle, where, for example, a source of 3D data has only one physical interface 410, e.g. DVI port.

In various embodiments, one or more interface chips or block 420 may provide the electronic decoding interface to physical interface 410. More specifically, similar to FIG. 8A, various data such as HSYNC, VSYNC, control lines, clocks, pixel data, or the like may be decoded by interface chips 420. Additionally, one or more interface chips or block 460 may be provided to reencode the HSYNC, VSYNC, pixel data, and the like into a format appropriate for the physical interface 460. In various embodiments, physical interface 460 may be a DVI port, HDMI port, Display Port (DP), USB, VESA 1997.11, or the like, for outputting data to a 3D display device (e.g. computer monitor, home entertainment monitor, projection device, etc.).

In various embodiments of the present invention, CPLD 430 is used in similar manner described in FIG. 8A, to decode data quickly. In various embodiments of the present invention, 3D synchronization data is then provided to an RF interface device 450 that references a clock 440. In some embodiments, RF interface device 450 is a TI CC2530 System on a Chip, that includes a 8051 MCU (processor), RAM, Flash memory, and a IEEE 802.14.4 ZigBee RF transceiver. The flash memory is configured to store executable computer code or instructions that directs the processor to perform various functions, as described herein. In various examples, the flash memory includes computer code that directs the processor to transmit the 3D synchronization data to the 3D glasses, to receive timing data back from the 3D glasses, to determine a round-trip communication latency, to adjust 3D synchronization data in response to the round-trip communication latency, and the like, as described above.

In FIG. 8B, dongle 400 is illustrated to be placed in-line within a DVI or HDMI signal path and to allow the video signal to behave as if it has passed through dongle 400 undisturbed, when it has in fact been decoded and reencoded.

FIG. 8C illustrates another contemplated embodiment, similar to FIG. 8B. More specifically, a dongle 800 with pass-through DVI/HDMI input and output interfaces is illustrated. In FIG. 8C, video signals need not be decoded or reencoded as shown in FIG. 8B. In various embodiments, one or more high impedance devices, such as FET probes 810, may be used to tap the video signals to derive the HSYNC, VSYNC, Control data, or the like. The monitored data can them be processed and output via RF signals to 3D glasses as described herein. The embodiments illustrated in FIG. 8C thus avoid the encoding and decoding processes and hardware of FIG. 8B, illustrated above.

In various embodiments of the present invention, data wires 820 coming from the source of 3D data, e.g. a GPU, includes an I2S clock and I2S data wires. As shown data wires 820 are also passed through dongle 800 to allow the display to communicate Plug and Play and configuration information back through dongle 800 and to the GPU. In various embodiments, the I2S bus, also called the Display Data Channel 2 or Plug and Play bus, is a multi-drop bus meaning it is electrically capable of supporting communications between three or more devices. Thus, in addition to providing the sequence information via a wireless link, the wireless link can now also be recognized by an application on the PC via the Display Data Channel 2. This allows other wireless communications such as upgrading or communicating with wireless shutter glasses, command and control, home automation, or the like.

As illustrated in FIGS. 8A-C, any other wired-type interface may also be provided. Illustrated in these figures is a VESA 1997.11 port. In other embodiments, the physical port may be a USB port, a firewire port, or any other custom/proprietary port. Additionally, in various embodiments, the interface may have a standard or proprietary signaling interface, for example, VESA 1997.11 specifies a specific signaling protocol. In other embodiments, in light of the present patent disclosure, one of ordinary skill in the art would recognize that a custom or proprietary signaling protocol may be implemented.

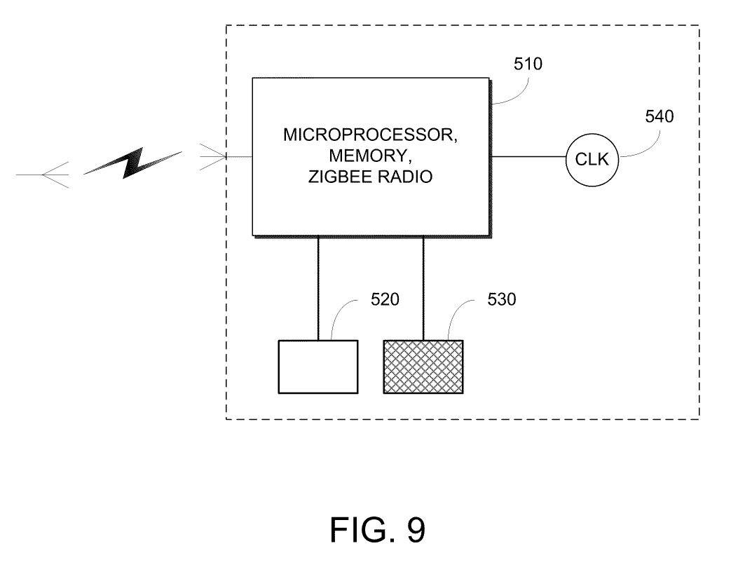

FIG. 9 illustrates various embodiments of the present invention. In particular, FIG. 9 illustrates a block diagram of a pair of shutter glasses 500 according to various embodiments of the present invention. Shutter glasses 500 is illustrated to include an RF interface device 510 that references a clock 540 and a pair of electronically controlled LCD shutter elements 520 and 530.

In various embodiments of the present invention, 3D synchronization data 550, typically radio frequency signals, is received in RF interface device 510. In various embodiments, RF interface device 510 is also an TI CC2530 System on a Chip, that includes a 8051 MCU (processor), RAM, Flash memory, and a IEEE 802.14.4 ZigBee RF transceiver. The flash memory is configured to store executable computer code or instructions that directs the processor to perform various functions, as described herein. In various examples, the flash memory includes computer code that directs the processor to receive the 3D synchronization data, to change the states of/drive shutter elements 520 and 530 at the appropriate timing (e.g. L1 and R1 in the sequence L1, L2, R1, R2), to send clock or timing data back to a transmission device via RF communications, and the like.

In other embodiments of the present invention, 3D glasses may be configured to transmit timing data back to the 3D source. The ability for bidirectional communications also allows a more precise timing protocol to be implemented between the 3D source and 3D glasses. As an example, the transmitter (3D source) and the receiver (3D glasses) each run local clocks that operate at a multiple of the frequency (e.g. 20 KHz) of the sequence information (e.g. 120 Hz) and are divided down to a lower speed which matches the sequence information. Then, the transmitter and the receiver exchange a series of messages at the higher frequency containing timestamps which indicate the value of their local clocks. By exchanging a series of these messages the transmitter and receiver can determine the difference in speed of their local clocks and compensate for these differences. The result is that synchronization is achieved with a much higher precision than the period of the sequence information.

In various embodiment, when there are multiple 3D displays and 3D transmitters present, a user using a pair of 3D glasses that perceives stereoscopic information from one 3D display should not also perceive stereoscopic information from another 3D display at the same time. This is unless each 3D display is synchronized in time and uses the same left/right sequence. For example, all the 3D displays must start the left frame at the same time and the right frame at the same time. In examples such as an event with multiple monitors, synchronization between these 3D displays may be performed by coordination of the 3D source devices or a single 3D source device.

In light of the above disclosure, one of ordinary skill in the art would recognize that many variations may be implemented based upon the discussed embodiments. Embodiments described above may be useful for hand-held consumer devices such as cell-phones, personal media players, mobile internet devices, or the like. Other embodiments may also be applied to higher-end devices such as laptop computers, desktop computers, DVRs. BluRay players, gaming consoles, hand-held portable devices, or the like. Other embodiments may take advantage of existing IR transmission devices for IR shutter glasses. More specifically, in such embodiments, an IR to RF conversion portion may be added to receive the IR 3D output instructions and to convert them to RF 3D transmission signals, described above. In some embodiments, an RF receiver is thus used. The RF 3D transmission signals are then transmitted to the RF 3D shutter glasses, described above. Such embodiments can therefore be a simple upgrade to available IR 3D glasses transmitters.

In other embodiments of the present invention, feedback from shutter glasses to the transmitter device described above with regards to synchronization, may be used for additional purposes. One such embodiment may allow the 3D image source (e.g. a cable box, computer, or the like) to take the indication that a pair of shutter glasses are currently synchronized to mean a person is viewing the 3D content, and to provide that data back to a marketing company such as Media Metrics, Nielsen Ratings, or the like. By doing this, such market research companies may determine the number of viewers of specific 3D features, or the like.

The above detailed description is directed to systems, methods, and computer-readable media for stereoscopic viewing. While the subject matter described herein is presented in the general context of program modules that execute in conjunction with the execution of an application program or an operating system on a 3D source, consumer electronics device, and a pair of stereoscopic glasses, those skilled in the art will recognize that other implementations may be performed in combination with other program modules or devices.

Further embodiments can be envisioned to one of ordinary skill in the art after reading this disclosure. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope.

What is claimed is:

1. A method for driving a pair of three-dimensional glasses comprising:
receiving 3D video output signals from a source of 3D video signals;
determining a plurality of synchronization signals in response to the 3D video output signals;
outputting radio frequency signals to the pair of three-dimensional glasses in response to the plurality of synchronization signals.

2. The method of claim 1
wherein receiving 3D video output signals comprise receiving intermittent sequence information and picture data multiplex from the source of 3D video signals on an interface;
wherein the interface is selected from a group consisting of: Digital Visual Interface (DVI), High-Definition Multimedia Interface (HDMI).

3. The method of claim 2
wherein the plurality of synchronization signals are determined in response to the sequence information; and
wherein the intermittent sequence information is transmitted substantially synchronously with transmission of signals from the picture data, wherein picture data is selected from a group consisting of: HBLANK, VBLANK, control information

4. The method of claim 3 wherein the method further comprises determining continuous sequence information comprising:
decoding the intermittent sequence information; and
reassembling the intermittent sequence information to form the continuous sequence information.

5. The method of claim 4 wherein the intermittent sequence information is characterized by a rate selected from a first range of frequencies;
wherein the continuous sequence information is characterized by a rate selected from a second range of frequencies; and
wherein frequencies within the first range are greater than three orders of magnitude greater than frequencies within the second range.

6. The method of claim 5 wherein the first range of frequencies is from 32 MHz to 340 Mhz.

7. The method of claim 4
wherein decoding the intermittent sequence information is performed with a device selected from a group consisting of: a state machine, Programmable Logic Device, Complex Programmable Logic Device, Field Programmable Gate Array; and
wherein reassembling the intermittent sequence information is performed with a device selected from a group consisting of: a state machine, a microprocessor, microcontroller.

8. The method of claim 1
wherein the plurality of synchronization signals are output onto an interface;
wherein the interface is selected from a group consisting of: a 1997.11 VESA Connector & Signal Standards for Stereoscopic Display Hardware standard interface, a USB interface, a proprietary interface.

9. The method of claim 1 in which radio frequency signals comprise IEEE 802.15.4 compatible signals.

10. The method of claim 1 further comprising outputting the 3D video output signals to a 3D display.

11. A device for driving a pair of three-dimensional glasses comprising:
an interface portion configured to receive 3D video output signals from a source of 3D video signals;
a decoding portion configured to determine a plurality of synchronization signals in response to the 3D video output signals;
a radio frequency transmitter configured to output radio frequency signals to the pair of three-dimensional glasses in response to the plurality of synchronization signals.

12. The device of claim 11
wherein the interface portion is configured to receive 3D video output signals comprising intermittent sequence information and picture data multiplex from the source of 3D video signals on a physical interface; and
wherein the physical interface is selected from a group consisting of: Digital Visual Interface (DVI), High-Definition Multimedia Interface (HDMI).

13. The device of claim 12
wherein the decoding portion is configured to determine the plurality of synchronization signals in response to the intermittent sequence information; and
wherein decoding portion is configured to receive the intermittent sequence information substantially synchronously with transmission of signals from the picture data, wherein picture data is selected from a group consisting of: HBLANK, VBLANK, control information, Plug and Play information, EDID information.

14. The device of claim 13 wherein the decoding portion comprises a first decoder configured to decode the intermittent sequence information, and a reassembler configured to reassemble the intermittent sequence information to form continuous sequence information.

15. The device of claim 14 wherein the intermittent sequence information is characterized by a rate selected from a first range of frequencies;
wherein the continuous sequence information is characterized by a rate selected from a second range of frequencies; and
wherein frequencies within the first range are greater than three orders of magnitude greater than frequencies within the second range.

16. The device of claim 15 wherein the first range of frequencies is from 32 MHz to 340 Mhz.

17. The device of claim 14
wherein the first decoder is selected from a group consisting of: a state machine, a Programmable Logic Device, Complex Programmable Logic Device, Field Programmable Gate Array; and
wherein the reassemble is selected from a group consisting of: a state machine, a microprocessor, microcontroller.

18. The device of claim 11 further comprising:
a signal output configured to output the plurality of synchronization signals; and
an output interface, wherein the output interface is selected from a group consisting of: 1997.11 VESA Connector & Signal Standards for Stereoscopic Display Hardware standard interface, a USB interface, a proprietary interface.

19. The device of claim 11 wherein the radio frequency transmitter comprises a transmitter compatible with IEEE 802.15.4 signals.

20. The device of claim 11 further comprising an 3d video output port configured to provide the 3D video output signals to a 3D display.
